(19) United States
(12) Patent Application Publication
(10) Pub. No.: US 2025/0338322 A1
(43) Pub. Date: Oct. 30, 2025

(54) BEACON ADJUSTMENT METHOD AND BEACON ADJUSTMENT DEVICE

(71) Applicant: REALTEK SEMICONDUCTOR CORPORATION, Hsinchu (TW)

(72) Inventor: Ying-Chuan Chen, Hsinchu (TW)

(21) Appl. No.: 19/097,948

(22) Filed: Apr. 2, 2025

(30) Foreign Application Priority Data
Apr. 26, 2024 (TW) 113115869

(51) Int. Cl. H04W 74/0833; H04W 74/08

(52) U.S. Cl. CPC H04W 74/0858; H04W 74/085; H04W 74/0891

(57) ABSTRACT

A beacon adjustment method is applied in a wireless access point (AP). The beacon adjustment method includes following steps: detecting at least one signal or at least one signal collision event; calculating an adjustment base according to the at least one signal or the at least one signal collision event; and adjusting a target beacon transmission time (TBTT) according to the adjustment base, or adjusting a timing value of a timing synchronization function (TSF) according to the adjustment base.

### BACKGROUND OF THE INVENTION

### 1. Field of the Invention

The present disclosure relates to a beacon adjustment method and a beacon adjustment device, especially to a beacon adjustment method and a beacon adjustment device that may adjust a target beacon transmission time or a timing synchronization function according to a signal or a signal collision event which are detected.

### 2. Description of Related Art

In the field of wireless communication, wireless network (e.g., Wi-Fi) technology has been widely applied to various electronic devices. For maintaining a connection quality between a Wi-Fi wireless access point (AP) and other wireless devices (e.g., Station, STA), the wireless access point must be able to transmit beacons stably and continuously.

If the wireless access point fails to transmit beacons, or if beacons output by the wireless access point cannot be transmitted to other wireless devices, the wireless devices will extend their idle time while waiting for beacons. Furthermore, the wireless devices may directly disconnect from the wireless access point.

### SUMMARY OF THE INVENTION

In some aspects, an object of the present disclosure is to, but not limited to, provides a beacon adjustment method and a beacon adjustment device that makes an improvement to the prior art.

An embodiment of a beacon adjustment method which is applied in a wireless access point of the present disclosure includes: detecting at least one signal or at least one signal collision event; calculating an adjustment base according to the at least one signal or the at least one signal collision event; and adjusting a target beacon transmission time according to the adjustment base, or adjusting a timing value of a timing synchronization function according to the adjustment base.

An embodiment of a beacon adjustment device of the present disclosure includes a processor. The processor is configured to execute at least one instruction to execute following steps: detecting at least one signal or at least one signal collision event; calculating an adjustment base according to the at least one signal or the at least one signal collision event; and adjusting a target beacon transmission time according to the adjustment base, or adjusting a timing value of a timing synchronization function according to the adjustment base.

Technical features of some embodiments of the present disclosure make an improvement to the prior art. The beacon adjustment method and the beacon adjustment device of the present disclosure can adjust the target beacon transmission time or the timing synchronization function according to the signal or the signal collision event which are detected. Therefore, the present disclosure can avoid collisions between transmitted beacons and other signals to effectively transmit beacons to wireless devices.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a beacon adjustment device of the present disclosure.

FIG. 2 shows an embodiment of a flow diagram of a beacon adjustment method of the present disclosure.

FIG. 3 shows an embodiment of operations of a beacon adjustment device of the present disclosure.

FIG. 4 shows an embodiment of operations of a beacon adjustment device of the present disclosure.

FIG. 5 shows an embodiment of operations of a beacon adjustment device of the present disclosure.

FIG. 6 shows an embodiment of operations of a beacon adjustment device of the present disclosure.

FIG. 7 shows an embodiment of operations of a beacon adjustment device of the present disclosure.

FIG. 8 shows an embodiment of operations of a beacon adjustment device of the present disclosure.

FIG. 9 shows an embodiment of operations of a beacon adjustment device of the present disclosure.

FIG. 10 shows an embodiment of operations of a beacon adjustment device of the present disclosure.

### DETAILED DESCRIPTION OF THE PREFERRED EMBODIMENTS

To improve the problem in the prior art that beacons cannot be effectively transmitted to wireless devices, leading to extended idle time of wireless devices and even disconnection from the Wi-Fi wireless access point (AP), the present disclosure provides a beacon adjustment device and a beacon adjustment method, which will be explained in detail as below.

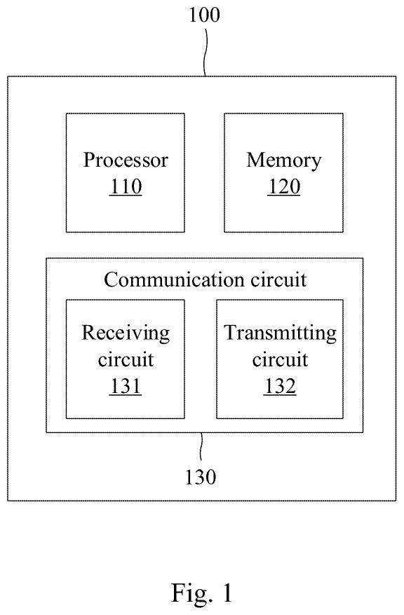

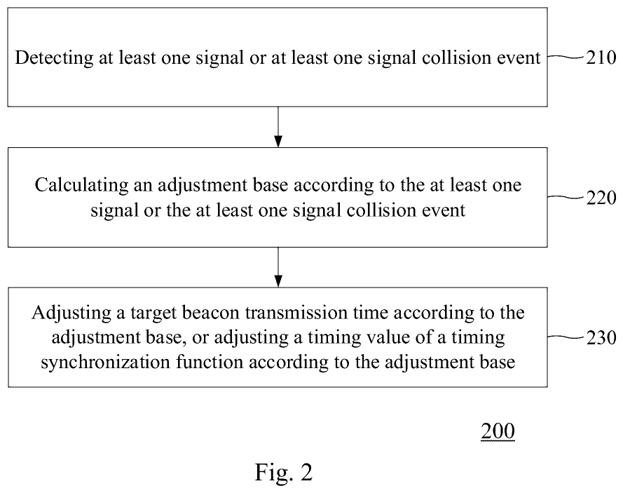

FIG. 1 shows an embodiment of a beacon adjustment device 100 of the present disclosure. As shown in the figure, the beacon adjustment device 100 includes a processor 110, a memory 120, and a communication circuit 130. The processor 110, the memory 120, and the communication circuit 130 are electrically coupled to each other. The memory 120 is configured to store at least one instruction. The processor 110 is configured to execute the at least one instruction to execute a beacon adjustment. The communication circuit 130 further includes a receiving circuit 131 and a transmitting circuit 132, which are primarily configured to receive and transmit packets. To facilitate understanding of operations of the beacon adjustment device 100, reference is also made to FIG. 2. FIG. 2 shows an embodiment of a flow diagram of a beacon adjustment method 200 of the present disclosure. In some embodiments, the beacon adjustment method 200 may be applied in a wireless access point. In some embodiments, the beacon adjustment method 200 may be applied in a hotspot of a wireless device (Station, STA), and the wireless device can be, for example, a mobile phone. The hotspot can be, for example, a software enabled access point (Soft AP) or a mobile access point (mobile AP).

Reference is now made to FIG. 1 and FIG. 2. In step 210, detecting at least one signal or at least one signal collision event. For example, the aforementioned signal may include packets or energy. The receiving circuit 131 of the communication circuit 130 of the present disclosure can execute detection through Clear Channel Assessment (CCA) or Energy Detection Clear Channel Assessment (EDCCA). The communication circuit 130 of the present disclosure can detect packets and check the headers of the packets to determine whether they are Wi-Fi packets by utilizing the above techniques. Additionally, the communication circuit 130 of the present disclosure can also detect energy in a channel. If the detected energy significantly exceeds a preset threshold, it represents that the channel is currently in use. In other words, energy is being transmitted in the channel. On the other hand, if other signal is still detected after the signal is transmitted, it represents that the signal (e.g., a beacon (BCN)) transmitted by the transmitting circuit 132 of the communication circuit 130 of the present disclosure will still encounter a signal collision event with the other signal. It should be noted that the present disclosure is not limited to the above-mentioned embodiments. In other embodiments, other appropriate techniques can also be adopted to detect signals, depending on actual requirements.

In step 220, calculating an adjustment base according to the at least one signal or the at least one signal collision event. For example, the aforementioned signal may include packets or energy. After detecting a signal or a signal collision event, the communication circuit 130 of the present disclosure can determine the time point at which the signal or the signal collision event occurred according to the signal or the signal collision event and calculate the adjustment base accordingly.

In step 230, adjusting a target beacon transmission time according to the adjustment base, or adjusting a timing value of a timing synchronization function according to the adjustment base. For example, the foregoing signal may include packets or energy. The communication circuit 130 of the present disclosure can utilize the adjustment base to adjust the target beacon transmission time (TBTT) or adjust the timing value of the timing synchronization function (TSF) according to the adjustment base so as to avoid time points at which other signals or other signal collision events occur, thereby enabling the transmitting circuit 132 of the communication circuit 130 to effectively transmit signals (e.g., beacons) to wireless devices (e.g., mobile phones, tablets, laptops, and other wireless electronic products). In view of the above, the beacon adjustment device 100 of the present disclosure can prevent wireless devices from extending their idle time while waiting for beacons or even disconnecting from the wireless access point.

In some embodiments, the beacon adjustment device 100 of the present disclosure can directly adjust the target beacon transmission time according to the adjustment base or adjust the timing value of the timing synchronization function according to the adjustment base to adjust the target beacon transmission time TBTT. For example, the beacon adjustment device 100 of the present disclosure can directly adjust the target beacon transmission time according to the adjustment base. Alternatively, the beacon adjustment device 100 of the present disclosure can adjust the timing value of the timing synchronization function (TSF) according to the adjustment base and output the timing synchronization function (TSF) to other wireless devices. When other wireless devices receive the foregoing timing value of the timing synchronization function (TSF), other wireless devices will update their timing values of the timing synchronization function (TSF) to align with the timing value of the timing synchronization function (TSF) of the beacon adjustment device 100 of the present disclosure, thereby ensuring that the target beacon transmission time TBTT of the beacon adjustment device 100 aligns with the target beacon transmission time TBTT of other wireless devices. In view of the above, the beacon adjustment device 100 of the present disclosure can indeed achieve the adjustment of the target beacon transmission time TBTT by adjusting the timing value of the timing synchronization function (TSF). Additionally, since other signals may be transmitted by other wireless access points, and other signals may appear periodically. To avoid collisions between the signal transmitted by the beacon adjustment device 100 of the present disclosure and other signals, the beacon adjustment device 100 of the present disclosure can adjust the target beacon transmission time TBTT so that the signal transmitted by the beacon adjustment device 100 of the present disclosure in the next cycle has a larger time gap (e.g., a 50-millisecond gap) from other signals transmitted by other wireless access points in the next cycle. As a result, the foregoing adjustment ensures that the signal transmitted by the beacon adjustment device 100 of the present disclosure in the next cycle does not collide with other signals transmitted by other wireless access points in the next cycle.

In some embodiments, the beacon adjustment device 100 of the present disclosure can detect the signal or the signal collision event through its communication circuit 130. For example, the communication circuit 130 of the beacon adjustment device 100 of the present disclosure may be a physical layer circuit. Subsequently, the communication circuit 130 of the beacon adjustment device 100 of the present disclosure can transmit related information of the signal or the signal collision event to the hardware circuit of the Media Access Control (MAC) layer through software running by the processor 110 so that the hardware circuit can adjust the target beacon transmission time TBTT.

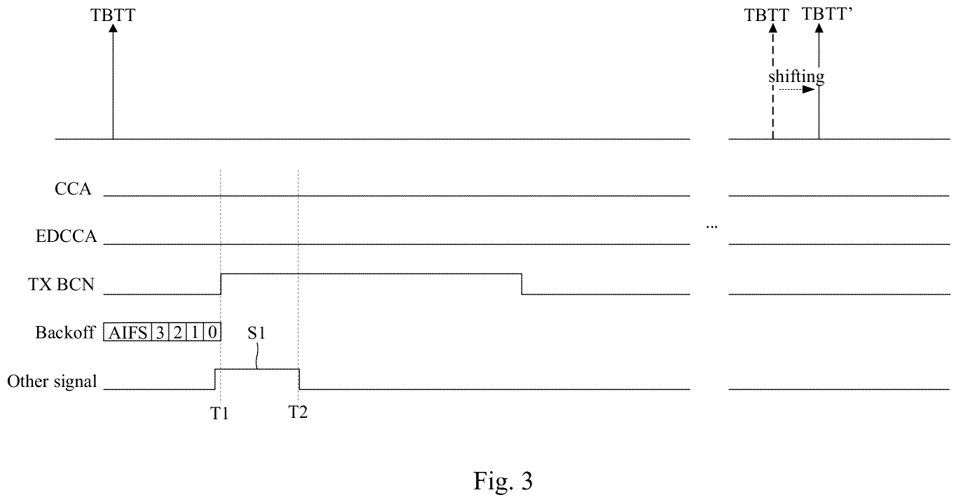

To effectively transmit beacons, the beacon adjustment device 100 of the present disclosure can adopt an active beacon adjustment mode or a passive beacon adjustment mode. For example, in the passive beacon adjustment mode, referring to FIG. 3, after the communication circuit 130 of the beacon adjustment device 100 of the present disclosure transmits a beacon BCN, it can detect whether a signal collision event occurs. As shown in the figure, the communication circuit 130 of the beacon adjustment device 100 of the present disclosure detects that during the period from time T1 to time T2, there are both the beacon BCN transmitted by the communication circuit 130 and another signal S1. As a result, the beacon BCN transmitted by the communication circuit 130 of the present disclosure will collide with other signal S1, thereby affecting the transmission of the beacon BCN.

To avoid a collision event between the beacon BCN transmitted by the communication circuit 130 of the beacon adjustment device 100 of the present disclosure and the foregoing signal, the processor 110 of the beacon adjustment device 100 of the present disclosure can calculate an offset according to the signal collision event to shift the original target beacon transmission time TBTT to a new target beacon transmission time TBTT′ according to the offset. In view of the above, the transmission time of the next beacon BCN will be staggered from the foregoing other signal to prevent other collision events from occurring to effectively transmit the beacon BCN to wireless devices. For example, if the occurrence time of other signal S1 is set to 0, the beacon BCN occurs at 2 microseconds (μs) (equivalent to 0.002 milliseconds (ms)). Since the time difference between other signal S1 and the beacon BCN is small, a collision event occurs. The foregoing other signal S1 may be transmitted by other wireless access point and may appear periodically. For instance, the foregoing other signal S1 may appear every 100 milliseconds periodically. For example, the foregoing other signal S1 might occur at 0 ms (initial), 100 ms (next cycle), 200 ms (the following cycle), and so on. On the other hand, the beacon BCN also appears every 100 milliseconds periodically. For instance, the beacon BCN appears at 0.002 ms (initial), 100.002 ms (next cycle), 200.002 ms (the following cycle), and so on. To avoid repeated collision events, the beacon adjustment device 100 of the present disclosure can shift the occurrence time of the beacon BCN in the next cycle by 50 milliseconds through adjusting the target beacon transmission time TBTT to change the occurrence time of the beacon BCN from 100.002 ms to 150.002 ms. Meanwhile, the occurrence time of the foregoing other signal S1 in the next cycle remains at 100 ms. As a result, in the next cycle, the beacon BCN (occurring at 150.002 ms) will be staggered from the foregoing other signal S1 (occurring at 100 ms) so that the above-mentioned adjustment ensures a significant time gap (e.g., a gap of 50 ms or more) between the beacon BCN transmitted by the beacon adjustment device 100 of the present disclosure in the next cycle and the foregoing other signal S1 transmitted by other wireless access points in the next cycle. Consequently, the beacon BCN transmitted by the beacon adjustment device 100 of the present disclosure in the next cycle will no longer collide with the foregoing other signal S1 transmitted by other wireless access points in the next cycle.

Referring to FIG. 3, in an embodiment of the passive beacon adjustment mode, before the communication circuit 130 of the beacon adjustment device 100 of the present disclosure transmits a beacon BCN, it will wait for an arbitration inter-frame spacing (AIFS) time. After the AIFS time, it begins a countdown (Backoff). In this embodiment, the processor 110 of the beacon adjustment device 100 of the present disclosure needs to complete four countdowns before transmitting the beacon BCN. As shown in the figure, after the processor 110 of the beacon adjustment device 100 of the present disclosure completes the countdowns for 3, 2, and 1, it begins the countdown for 0. During the countdown for 0, the communication circuit 130 of the beacon adjustment device 100 of the present disclosure detects other signal S1. However, since the processor 110 of the beacon adjustment device 100 of the present disclosure already begins the countdown for 0, it is too late for the processor 110 of the beacon adjustment device 100 of the present disclosure to stop the transmission of the beacon BCN, resulting in a collision event between the beacon BCN and the foregoing other signal S1. The processor 110 of the beacon adjustment device 100 of the present disclosure can calculate a displacement according to the signal collision event and shift the original target beacon transmission time TBTT to a new target beacon transmission time TBTT′ according to the displacement to prevent other collision events from occurring to effectively transmit the beacon BCN to wireless devices. In some embodiments, specifically, during the countdown for 0, if the occurrence time of the foregoing other signal S1 is set as the origin point, the occurrence time of the beacon BCN would be 0.002 milliseconds. Because the time difference between the foregoing other signal S1 and the beacon BCN is only 0.002 milliseconds, the processor 110 of the beacon adjustment device 100 of the present disclosure cannot stop the transmission of the beacon BCN in time, resulting in a collision event between the beacon BCN and the foregoing other signal S1.

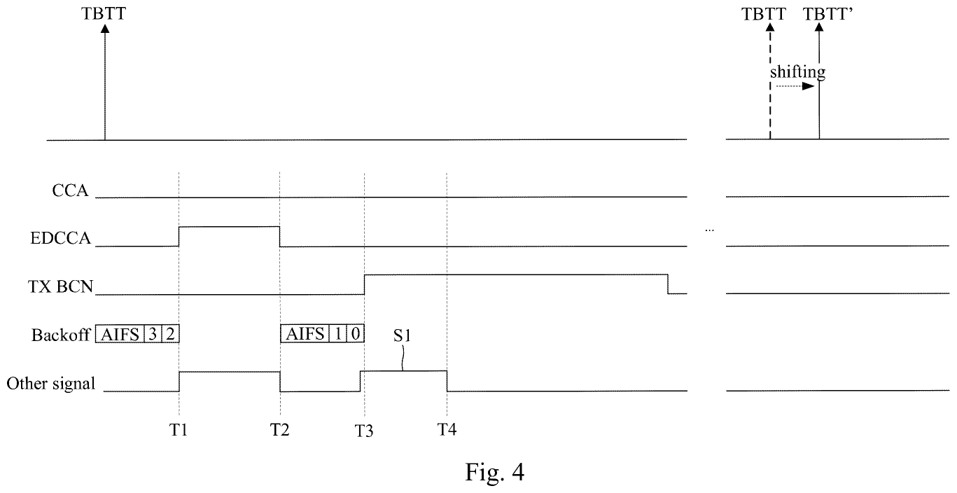

Referring to FIG. 4, in another embodiment of the passive beacon adjustment mode, after the processor 110 of the beacon adjustment device 100 of the present disclosure waits for an arbitration inter-frame spacing (AIFS) time, it begins a countdown. During the countdown at time T1, other signal is detected by using the EDCCA mechanism. At this point, it must wait for the foregoing other signal to complete transmission. After time T2, it waits for another AIFS time and resumes the countdown from number 1. The countdown continues until it reaches 0 without detecting any other signals. At this point, the communication circuit 130 of the beacon adjustment device 100 of the present disclosure transmits the beacon BCN at time T3. It should be noted that during the two countdown phases, the processor 110 of the beacon adjustment device 100 of the present disclosure continues the countdown sequentially. In other words, during the two countdowns, it counts down as 3, 2, 1, 0 sequentially. Specifically, in the second countdown phase, the processor 110 of the beacon adjustment device 100 of the present disclosure resumes counting down from 1 instead of restarting from 3. This is because if the processor 110 of the beacon adjustment device 100 of the present disclosure restarts the countdown from 3 each time and a signal is detected, it may result in the processor 110 of the beacon adjustment device 100 of the present disclosure being unable to successfully transmit the beacon. However, the present disclosure is not limited to the above-mentioned embodiment. In other embodiments, the present disclosure may adopt different countdown values, depending on actual requirements.

As shown in FIG. 4, after the beacon BCN is transmitted, the communication circuit 130 of the beacon adjustment device 100 of the present disclosure detects other signal S1. To avoid a collision event between the beacon BCN transmitted by the communication circuit 130 of the beacon adjustment device 100 of the present disclosure and the foregoing other S1, the processor 110 of the beacon adjustment device 100 of the present disclosure follows the mechanism described in the embodiment of FIG. 3 to shift the original target beacon transmission time TBTT to a new target beacon transmission time TBTT′ according to the signal collision event to prevent other collision events from occurring to effectively transmit the beacon BCN to wireless devices.

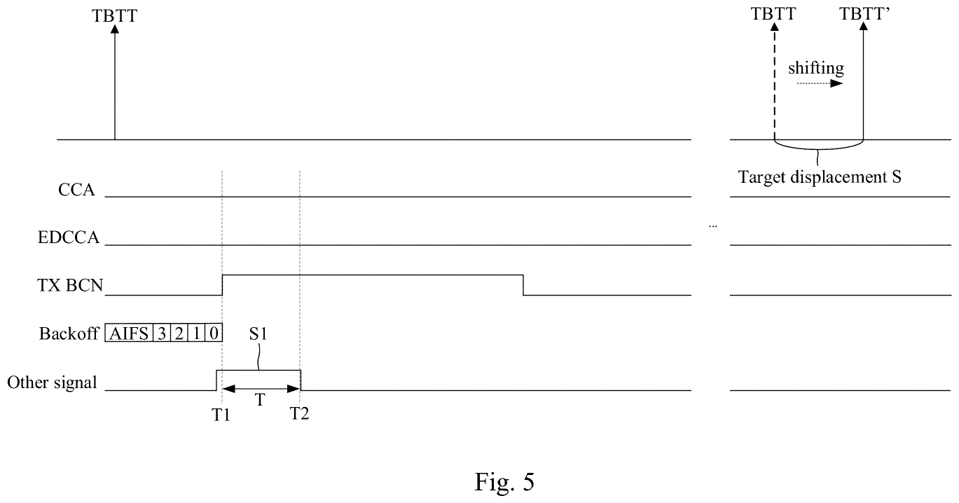

Referring to FIG. 5, in another embodiment of the passive beacon adjustment mode, after the communication circuit 130 of the beacon adjustment device 100 of the present disclosure transmits the beacon BCN, it can detect whether a signal collision event occurs. As shown in the figure, the communication circuit 130 of the beacon adjustment device 100 of the present disclosure detects the presence of other signal S1 during the period from time T1 to time T2. The beacon BCN transmitted by the communication circuit 130 of the beacon adjustment device 100 of the present disclosure will collide with the foregoing other signal S1, thereby affecting the transmission of the beacon.

To avoid a collision event between the beacon BCN transmitted by the communication circuit 130 of the beacon adjustment device 100 of the present disclosure and the foregoing other signal S1, the processor 110 of the beacon adjustment device 100 of the present disclosure can calculate an offset T according to the duration of the signal collision event, and shift the original target beacon transmission time TBTT by a target displacement S to a new target beacon transmission time TBTT′ according to the offset T. The target displacement S is greater than the offset T. In view of the above, since the new target beacon transmission time TBTT′ can further avoid the foregoing other signal S1, it can further ensure that the transmission time of the next beacon BCN will be staggered from the foregoing other signal to prevent other collision events from occurring to effectively transmit the beacon BCN to wireless devices.

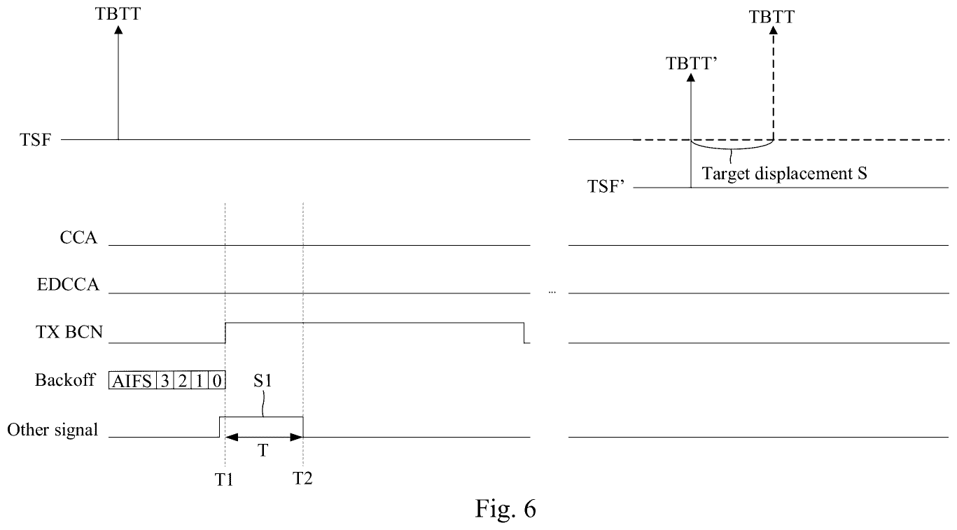

FIG. 6 shows an embodiment of operations of a beacon adjustment device 100 of the present disclosure. As shown in FIG. 6, it illustrates another embodiment of the passive beacon adjustment mode. Compared to the embodiment in FIG. 5, which utilizes an adjustment of the target beacon transmission time TBTT to avoid collision events, the embodiment in FIG. 6 adopts an adjustment of the timing synchronization function TSF to avoid collision events. Specifically, referring to FIG. 5, the processor 110 of the beacon adjustment device 100 of the present disclosure directly shifts the original target beacon transmission time TBTT by the target displacement S to the new target beacon transmission time TBTT′. In contrast, referring to FIG. 6, the timing synchronization function TSF includes a counter functionality. The horizontal axis of FIG. 6 represents the timing value of the timing synchronization function TSF. The processor 110 of the beacon adjustment device 100 of the present disclosure calculates an offset T according to the duration of the signal collision event and resets the timing value of the timing synchronization function TSF of the horizontal axis of FIG. 6 to zero according to the offset T for producing the timing value of the new timing synchronization function TSF′ as shown on the horizontal axis of FIG. 6. The above-mentioned operation is equivalent to shifting the timing value of the timing synchronization function TSF on the horizontal axis of FIG. 6 by the target displacement S to the timing value of the new timing synchronization function TSF′ as shown on the horizontal axis of FIG. 6. Once the timing value of the timing synchronization function TSF is reset to zero and updated to the timing value of the new timing synchronization function TSF′, the original target beacon transmission time TBTT is also synchronously updated to the new target beacon transmission time TBTT′ to prevent other collision events from occurring to effectively transmit the beacon BCN to wireless devices.

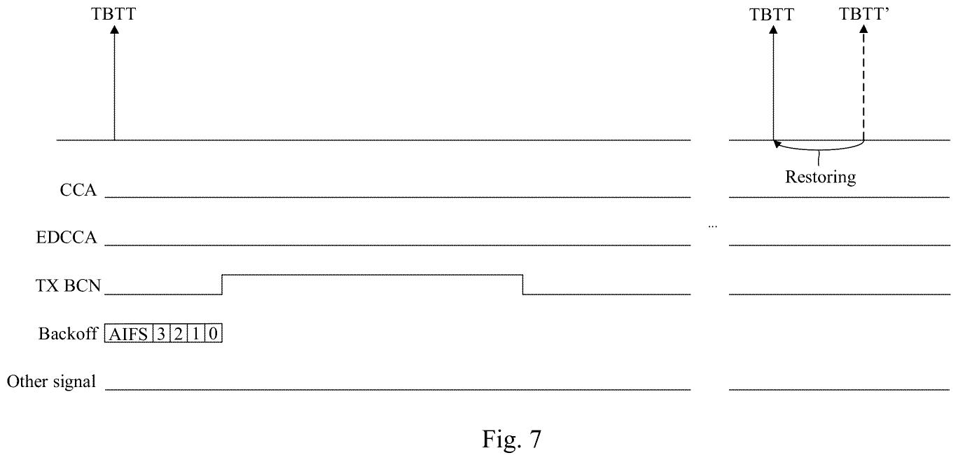

FIG. 7 shows an embodiment of operations of a beacon adjustment device 100 of the present disclosure. As shown in FIG. 7, it illustrates another embodiment of the passive beacon adjustment mode. It is assumed that the communication circuit 130 of the beacon adjustment device 100 of the present disclosure previously detected other signal S1, and the processor 110 of the beacon adjustment device 100 of the present disclosure already shifted the original target beacon transmission time TBTT to a new target beacon transmission time TBTT40 . If no signal collision event is subsequently detected as shown in FIG. 7, the processor 110 of the beacon adjustment device 100 of the present disclosure can restore the new target beacon transmission time TBTT′ to the original target beacon transmission time TBTT.

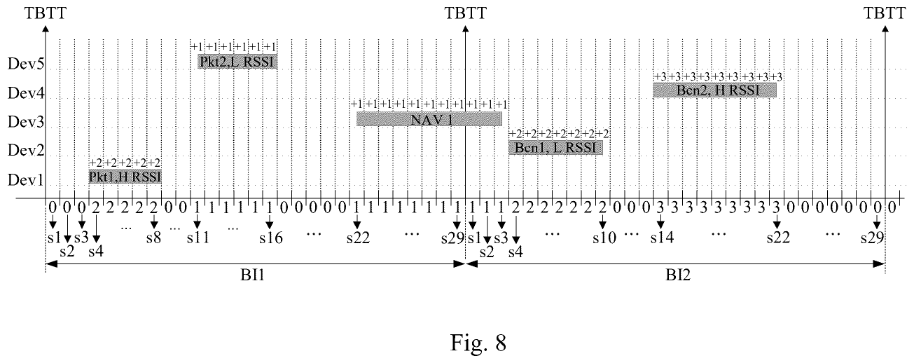

FIG. 8 shows an embodiment of operations of a beacon adjustment device 100 of the present disclosure. As shown in FIG. 8, it illustrates an embodiment of the active beacon adjustment mode. First, the communication circuit 130 of the beacon adjustment device 100 of the present disclosure detects signals (e.g., beacons) within at least two beacon intervals. A beacon interval refers to the time interval between the transmission of two beacons. For example, the above-mentioned beacon interval can be beacon intervals BI1 or BI2 between two beacons output by the communication circuit 130 of the beacon adjustment device 100 of the present disclosure.

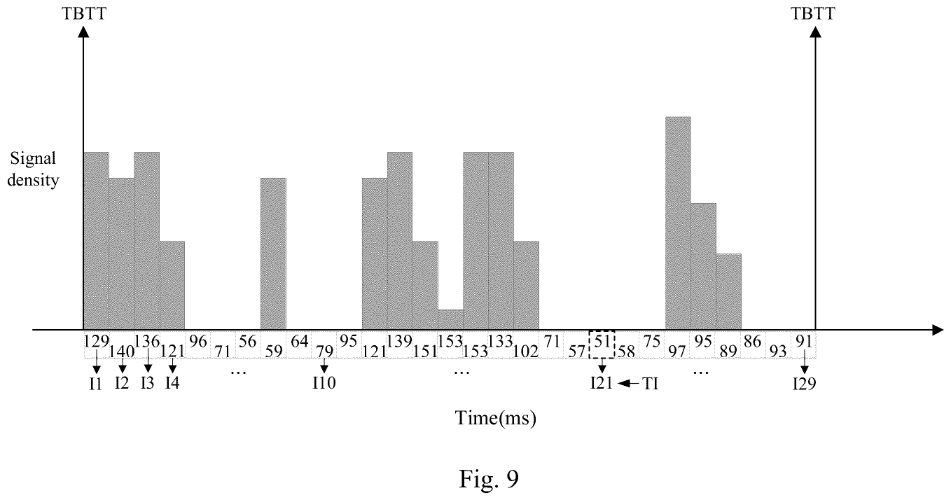

As shown in FIG. 8, the communication circuit 130 of the beacon adjustment device 100 of the present disclosure detects a plurality of signals during two beacon intervals BI1, BI2 and establishes a histogram as illustrated in FIG. 9 according to the detected signals. Subsequently, the processor 110 of the beacon adjustment device 100 of the present disclosure calculates a plurality of signal densities according to the histogram in FIG. 9 and sets the interval I21 with the lowest signal density as a target interval TI. For example, the processor 110 of the beacon adjustment device 100 of the present disclosure establishes the histogram according to the signals. For example, intervals with signals correspond to larger values, and interval without signals correspond to smaller values. Using this approach, the histogram is established. Subsequently, the signal density of each interval is calculated based on the value of the interval itself and the values of its adjacent intervals. For instance, the signal density of the interval I3 is calculated based on the value of the interval I3 itself and the values of its adjacent intervals (e.g., intervals I2 and I4). After completing the signal density calculations, it can be seen from FIG. 9 that the interval I21 has the lowest signal density. Therefore, the interval I21 is set as the target interval TI.

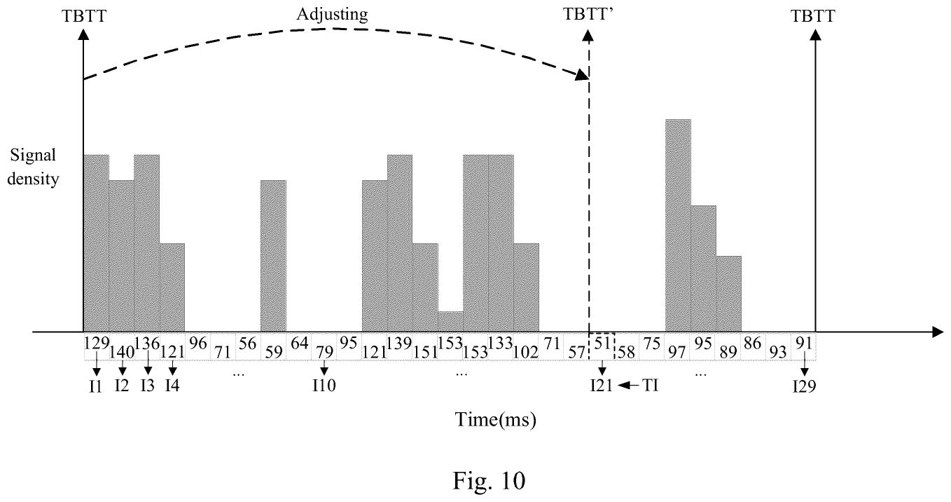

Subsequently, as shown in FIG. 10, the processor 110 of the beacon adjustment device 100 of the present disclosure adjusts the target beacon transmission time TBTT to a new target beacon transmission time TBTT′ according to a target interval TI. For example, the processor 110 of the beacon adjustment device 100 of the present disclosure may adjust the target beacon transmission time TBTT to the new target beacon transmission time TBTT′ by adjusting the timing synchronization function TSF. Since the target interval TI is the interval with the lowest signal density, which is actively detected and calculated by the beacon adjustment device 100 of the present disclosure, it represents that a probability of other signals appearing in the target interval TI is low. If the new target beacon transmission time TBTT′ is adjusted to the target interval TI, the probability of collision events occurring for the beacon transmitted by the communication circuit 130 of the beacon adjustment device 100 of the present disclosure is reduced to prevent other collision events from occurring to effectively transmit the beacon BCN to wireless devices.

Referring to FIG. 8, in another embodiment of the active beacon adjustment mode, the communication circuit 130 of the beacon adjustment device 100 of the present disclosure detects signals Pkt1, Pkt2, Bcn1, Bcn2, and a network allocation vector NAV1 within at least two beacon intervals BI1, BI2. The foregoing signals Pkt1, Pkt2 are respectively transmitted by other wireless devices Dev1, Dev5 among the environment, the network allocation vector NAV1 is transmitted by other wireless device Dev3 in the environment, and the signals Bcn1, Bcn2 are respectively transmitted by other wireless devices Dev2, Dev4 in the environment. In some embodiments, the wireless devices Dev2, Dev4 may be wireless access points, and the wireless devices Dev2, Dev4 transmit the beacons Bcn1, Bcn2 respectively.

As shown in the figure, the received signal strength indication RSSI of the signal Pkt1 is high (indicated as H RSSI in FIG. 8), which means that the wireless device Dev1 transmitting the signal Pkt1 is closer to the beacon adjustment device 100 of the present disclosure and has a greater impact on the beacon adjustment device 100 of the present disclosure. Therefore, the sub-intervals s4˜s8 of the beacon interval BI1 corresponding to the signal Pkt1 are set to intensity level 2. In contrast, the sub-intervals s1˜s3 and s9˜s10 of the beacon interval BI1 have no signals and have no impact on the beacon adjustment device 100 of the present disclosure, so these intervals are set to intensity level 0. It should be noted that other sub-intervals without signals are similarly set to intensity level 0. Additionally, the received signal strength indication RSSI of the signal Pkt2 is low (indicated as L RSSI in FIG. 8), which means that the wireless device Dev5 transmitting the signal Pkt2 is farther from the beacon adjustment device 100 of the present disclosure and has a smaller impact on the beacon adjustment device 100 of the present disclosure. As a result, the sub-intervals s11˜s16 of the beacon interval BI1 corresponding to the signal Pkt2 are set to intensity level 1.

Furthermore, the sub-interval s22 of the beacon interval BI1 to the sub-interval s3 of the beacon interval BI2 contain the network allocation vector NAV1, which means that the wireless device Dev3 intends to transmit signals during this interval, and this will impact the beacon adjustment device 100 of the present disclosure. Therefore, the sub-interval s22 of the beacon interval BI1 to the sub-interval s3 of the beacon interval BI2 corresponding to the network allocation vector NAV1 are set to intensity level 1.

In some embodiments, the signal Bcn1 may be the beacon Bcn1, and the received signal strength indication RSSI of the beacon Ben1 is low, which means that the wireless device Dev2 transmitting the beacon Benl is relatively far from the beacon adjustment device 100 of the present disclosure. However, since the wireless device Dev2 transmitting the beacon Ben1 may be a wireless access point, it still has an impact on the beacon adjustment device 100 of the present disclosure. Therefore, the sub-intervals s4˜s10 of the beacon interval BI2 corresponding to the beacon Bcn1 are set to intensity level 2. Additionally, the signal Bcn2 may be the beacon Bcn2, and the received signal strength indication RSSI of the beacon Ben2 is high, which means that the wireless device Dev4 transmitting the beacon Bcn2 is relatively close to the beacon adjustment device 100 of the present disclosure. Furthermore, the wireless device Dev4 transmitting the beacon Bcn2 may be a wireless access point, and it has a greater impact on the beacon adjustment device 100 of the present disclosure. Therefore, the sub-intervals s14˜s22 of the beacon interval BI2 corresponding to the beacon Bcn2 are set to intensity level 3.

Signals or network allocation vectors transmitted by other wireless devices Dev1˜Dev5 affect the beacons transmitted by the communication circuit 130 of the beacon adjustment device 100 of the present disclosure. The degree of impact is related to the intensity levels of the foregoing sub-intervals. Therefore, the processor 110 of the beacon adjustment device 100 of the present disclosure actively executes adjustments according to the conditions of the signals or the network allocation vectors transmitted by other wireless devices Dev1˜Dev5 (e.g., the intensity levels of the sub-intervals corresponding to the signals or the network allocation vectors) to avoid collisions between the beacons transmitted by the communication circuit 130 of the beacon adjustment device 100 of the present disclosure and the signals transmitted by other wireless devices Dev1˜Dev5. Detailed explanations are provided below.

The processor 110 of the beacon adjustment device 100 of the present disclosure establishes the histogram illustrated in FIG. 9 according to the detected signals and network allocation vectors. Subsequently, the processor 110 of the beacon adjustment device 100 of the present disclosure calculates a plurality of signal densities corresponding to the signals Pkt1, Pkt2, Bcn1, Bcn2, and the network allocation vector NAV1 according to the histogram of FIG. 9 and selects the target interval TI in the histogram according to the signal densities. For example, the processor 110 of the beacon adjustment device 100 of the present disclosure calculates the signal density of 129 for the interval I1, the signal density of 140 for the interval 12, and the signal density of 136 for the interval I3, and so on, based on the histogram of FIG. 9, to obtain the signal densities for all intervals I1˜I29. Among the foregoing intervals I1˜I29, the interval with the lowest signal density is the interval I21. Therefore, the processor 110 of the beacon adjustment device 100 of the present disclosure selects the interval I21 with the lowest signal density as the target interval TI.

Subsequently, as shown in FIG. 10, the processor 110 of the beacon adjustment device 100 of the present disclosure shifts the target beacon transmission time TBTT to the target interval TI by adjusting the timing synchronization function TSF. In other words, the processor 110 of the beacon adjustment device 100 of the present disclosure can adjust the target beacon transmission time TBTT to a new target beacon transmission time TBTT′ by adjusting the timing synchronization function TSF. Since the target interval TI is the interval with the lowest signal density, which is actively detected and calculated by the beacon adjustment device 100 of the present disclosure, if the new target beacon transmission time TBTT′ is adjusted to the target interval TI, the probability of collision events occurring for the beacon transmitted by the communication circuit 130 of the beacon adjustment device 100 of the present disclosure is reduced to effectively transmit the beacon BCN to wireless devices.

As shown in FIG. 8, in some embodiments, signals appear in the sub-interval s4 of the beacon interval BI1 and the sub-interval s4 of the beacon interval BI2. For example, the signal Pkt1 appears in the sub-interval s4 of the beacon interval BI1, and the signal Bcn1 appears in the sub-interval s4 of the beacon interval BI2. The processor 110 of the beacon adjustment device 100 of the present disclosure deduces that the signals will regularly appear in the sub-intervals s4 of both beacon intervals BI1, BI2. To avoid a beacon transmitted by the communication circuit 130 of the beacon adjustment device 100 of the present disclosure colliding with the signals regularly appearing in the sub-intervals s4 of the beacon intervals BI1, BI2, the processor 110 of beacon adjustment device 100 of the present disclosure will set the sub-intervals s4 as interference intervals. The beacon adjustment device 100 of the present disclosure will subsequently avoid setting these interference intervals as the target interval TI to prevent the beacon transmitted by the communication circuit 130 of the beacon adjustment device 100 of the present disclosure from being affected. Following this method, if the sub-intervals s5, s6, s7, and s8 of the beacon intervals BI1, BI2 also regularly appear signals, the processor 110 of the beacon adjustment device 100 of the present disclosure will set these sub-intervals as interference intervals and will similarly avoid setting these interference intervals as the target interval TI. It should be noted that the processor 110 of the beacon adjustment device 100 of the present disclosure can use the same approach to set other intervals with regularly appearing signals as interference intervals.

In some embodiments, the beacon adjustment device 100 of the present disclosure may adopt a hybrid beacon adjustment mode, and the hybrid beacon adjustment mode may combine the advantages of both of the active beacon adjustment mode and the passive beacon adjustment mode. For example, the beacon adjustment device 100 of the present disclosure can utilize the active beacon adjustment mode described in the embodiments of FIGS. 8 to 10. In the active beacon adjustment mode, the beacon adjustment device 100 of the present disclosure can mark intervals where beacon BCN collisions occur as interference intervals. Suppose beacon BCN collides with the signal Pkt1 in sub-intervals s4˜s8, the beacon adjustment device 100 of the present disclosure can set sub-intervals s4˜s8 as interference intervals and subsequently avoid setting these interference intervals as the target interval TI. Additionally, the beacon adjustment device 100 of the present disclosure can determine the interval with the lowest signal density as the target interval TI according to the signal and adjust the new target beacon transmission time TBTT′ to the target interval TI to proactively avoid collision events. Moreover, based on the active beacon adjustment mode, the beacon adjustment device 100 of the present disclosure can further utilize the passive beacon adjustment mode described in the embodiments of FIGS. 3 to 7. After a beacon is transmitted, it can calculate the offset according to the signal collision event and shift the original target beacon transmission time TBTT to a new target beacon transmission time TBTT′ according to the offset. In this way, the transmission time of the next beacon BCN will be staggered from the signal to prevent other collision events from occurring to effectively transmit the beacon BCN to wireless devices. It should be noted that the details of the active or passive beacon adjustment modes are described in the above-mentioned embodiments, and descriptions related thereto will be omitted herein for the sake of brevity.

It is noted that the present disclosure is not limited to the embodiments as shown in FIG. 1 to FIG. 10, they are merely examples for illustrating the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The beacon adjustment method and the beacon adjustment device of the present disclosure can adjust the target beacon transmission time or the timing synchronization function according to the signal or the signal collision event which are detected. Therefore, the present disclosure can avoid collisions between transmitted beacons and other signals to effectively transmit beacons to wireless devices.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A beacon adjustment method, applied in a wireless access point, comprising:
detecting at least one signal or at least one signal collision event;
calculating an adjustment base according to the at least one signal or the at least one signal collision event; and
adjusting a target beacon transmission time according to the adjustment base, or adjusting a timing value of a timing synchronization function according to the adjustment base.

2. The beacon adjustment method of claim 1, wherein adjusting the target beacon transmission time according to the adjustment base, or adjusting the timing value of the timing synchronization function according to the adjustment base comprises:
directly adjusting the target beacon transmission time according to the adjustment base, or adjusting the timing value of the timing synchronization function according to the adjustment base to adjust the target beacon transmission time.

3. The beacon adjustment method of claim 1, wherein detecting the at least one signal or the at least one signal collision event comprises:
after a beacon is transmitted, detecting whether the at least one signal collision event occurs.

4. The beacon adjustment method of claim 1, wherein calculating the adjustment base according to the at least one signal or the at least one signal collision event comprises:
calculating an offset according to a duration of the at least one signal collision event;
wherein adjusting the target beacon transmission time according to the adjustment base comprises:
shifting the target beacon transmission time by a target displacement according to the offset, wherein the target displacement is larger than the offset.

5. The beacon adjustment method of claim 1, wherein detecting the at least one signal or the at least one signal collision event comprises:
detecting the at least one signal within at least two beacon intervals.

6. The beacon adjustment method of claim 5, wherein calculating the adjustment base according to the at least one signal or the at least one signal collision event comprises:
establishing a histogram according to the at least one signal which is detected;
calculating a plurality of signal densities according to the histogram; and
setting a target interval according to the plurality of signal densities.

7. The beacon adjustment method of claim 6, wherein adjusting the target beacon transmission time according to the adjustment base comprises:
adjusting the target beacon transmission time according to the target interval.

8. The beacon adjustment method of claim 7, further comprising:
after a beacon is transmitted, detecting whether the at least one signal collision event occurs;
setting an interval where the at least one signal collision event occurs as an interference interval; and
avoiding setting the interference interval as the target interval.

9. The beacon adjustment method of claim 1, wherein detecting the at least one signal or the at least one signal collision event comprises:
detecting a plurality of signals and a plurality of network allocation vectors within at least two beacon intervals.

10. The beacon adjustment method of claim 9, wherein calculating the adjustment base according to the at least one signal or the at least one signal collision event comprises:
establishing a histogram according to the plurality of signals and the plurality of network allocation vectors which are detected;
calculating a plurality of signal densities of the plurality of signals and the plurality of network allocation vectors according to the histogram; and
selecting a target interval within the histogram according to the plurality of signal densities;
wherein adjusting the target beacon transmission time according to the adjustment base comprises:
shifting the target beacon transmission time to the target interval by adjusting the timing synchronization function.

11. A beacon adjustment device, comprising:
a processor, configured to execute at least one instruction to execute following steps:
detecting at least one signal or at least one signal collision event;
calculating an adjustment base according to the at least one signal or the at least one signal collision event; and
adjusting a target beacon transmission time according to the adjustment base, or adjusting a timing value of a timing synchronization function according to the adjustment base.

12. The beacon adjustment device of claim 11, wherein the step of adjusting the target beacon transmission time according to the adjustment base, or adjusting the timing value of the timing synchronization function according to the adjustment base comprises:
directly adjusting the target beacon transmission time according to the adjustment base, or adjusting the timing value of the timing synchronization function according to the adjustment base to adjust the target beacon transmission time.

13. The beacon adjustment device of claim 11, wherein the step of detecting the at least one signal or the at least one signal collision event comprises:
after a beacon is transmitted, detecting whether the at least one signal collision event occurs.

14. The beacon adjustment device of claim 11, wherein the step of calculating the adjustment base according to the at least one signal or the at least one signal collision event comprises:
calculating an offset according to a duration of the at least one signal collision event;
wherein the step of adjusting the target beacon transmission time according to the adjustment base comprises:
shifting the target beacon transmission time by a target displacement according to the offset, wherein the target displacement is larger than the offset.

15. The beacon adjustment device of claim 11, wherein the step of detecting the at least one signal or the at least one signal collision event comprises:
detecting the at least one signal within at least two beacon intervals.

16. The beacon adjustment device of claim 15, wherein the step of calculating the adjustment base according to the at least one signal or the at least one signal collision event comprises:
establishing a histogram according to the at least one signal which is detected;
calculating a plurality of signal densities according to the histogram; and
setting a target interval according to the plurality of signal densities.

17. The beacon adjustment device of claim 16, wherein the step of adjusting the target beacon transmission time according to the adjustment base comprises:
adjusting the target beacon transmission time according to the target interval.

18. The beacon adjustment device of claim 17, wherein the processor is further configured to execute the at least one instruction to execute following steps:
after a beacon is transmitted, detecting whether the at least one signal collision event occurs;
setting an interval where the at least one signal collision event occurs as an interference interval; and
avoiding setting the interference interval as the target interval.

19. The beacon adjustment device of claim 11, wherein the step of detecting the at least one signal or the at least one signal collision event comprises:
detecting a plurality of signals and a plurality of network allocation vectors within at least two beacon intervals.

20. The beacon adjustment device of claim 19, wherein the step of calculating the adjustment base according to the at least one signal or the at least one signal collision event comprises:
establishing a histogram according to the plurality of signals and the plurality of network allocation vectors which are detected;
calculating a plurality of signal densities of the plurality of signals and the plurality of network allocation vectors according to the histogram; and
selecting a target interval within the histogram according to the plurality of signal densities;
wherein the step of adjusting the target beacon transmission time according to the adjustment base comprises:
shifting the target beacon transmission time to the target interval by adjusting the timing synchronization function.
